(19) United States
(12) Patent Application Publication
(10) Pub. No.: US 2026/0032027 A1
(43) Pub. Date: Jan. 29, 2026

(54) ENVELOPE-BASED MODULATION CLASSIFICATION SYSTEMS AND METHODS

(71) Applicant: Purdue Research Foundation, West Lafayette, IN (US)

(72) Inventors: Dimitrios Peroulis, West Lafayette, IN (US); Mohammad Mahmoud Abu Khater, Savoy, IL (US)

(73) Assignee: Purdue Research Foundation, West Lafayette, IN (US)

(21) Appl. No.: 19/265,287

(22) Filed: Jul. 10, 2025

Related U.S. Application Data
(60) Provisional application No. 63/675,934, filed on Jul. 26, 2024.

(51) Int. Cl. H04L 27/00; G06N 3/0442

(52) U.S. Cl. CPC H04L 27/0012; G06N 3/0442

(57) ABSTRACT

Method and system for automatic modulation classification (AMC) use time-series voltage signals representative of radio frequency (RF) signal envelope and frequency components as input features to a deep learning-based neural network, which enables classification of both modulation type and symbol rate without requiring in-phase and quadrature (IQ) demodulation. A feature extraction circuit captures RF signal envelope amplitude and frequency using stub-based sensing, and a Long Short-Term Memory (LSTM) neural network processes these features in a digitized form to classify the modulation and symbol rate with high accuracy and minimal latency.

### CROSS-REFERENCE TO RELATED APPLICATIONS

This application is related to and claims the priority benefit of U.S. Provisional Application No. 63/675,934, entitled “Envelope Based Modulation Classification Systems and Methods” filed Jul. 26, 2024, the contents of which are hereby incorporated by reference in their entirety into the present disclosure.

### TECHNICAL FIELD

The present application relates generally to signal processing technologies, and, more particularly, to methods and systems for automatic modulation classification (AMC) using deep learning neural networks and envelope-based signal features.

### BACKGROUND

AMC is used to extract useful information about a specific signal from a crowded spectrum. As a result, this essential feature for cognitive radios, for example, has attracted numerous research works. The classification methods utilized can be generally categorized into the following sets: 1) maximum likelihood-based (e.g., cumulant expert functions), 2) distribution test-based, and 3) machine learning-based (primarily deep learning).

The maximum likelihood-based classification method relies on statistical probability models to determine the most likely modulation scheme. The distribution test-based approach evaluates signal characteristics against known probability distributions to classify modulations. The machine learning-based method leverages neural networks and other learning algorithms to automatically identify modulation types from input data.

Among these, the machine learning-based classification method has gained popularity in recent years since it requires minimal human intervention in the development stage. It also benefits from the significant advancements in hardware accelerator technologies. The known machine learning-based solutions, however, primarily rely on the availability of IQ data as the input to the classification system. This assumes that the receiver is operating properly and in the linear region. This makes them vulnerable to imperfections such as amplitude or phase imbalance, and gain compression.

Consequently, in the presence of a strong interferer in the band of interest, the methods above might not work properly, and there is a need for an alternative AMC method to identify the nature of the interfering signal. In addition, traditional methods primarily focus on identifying the modulation, without quantifying data/symbol rate.

### SUMMARY

Described herein is a technical solution for a deep learning-based AMC relying on the envelope of the signal and its frequency readings. As a result, the signals are detected in the radio frequency domain without downconversion, making this technical solution significantly more robust against high power interferers, while maintaining an excellent detection accuracy.

In one aspect of the described embodiments, a modulation classification system is provided, which can comprise: a feature extraction circuit configured to extract an envelope amplitude and a frequency of an input radio frequency signal; and one or more processing units configured to process the envelope amplitude and the frequency to classify a modulation type and a symbol rate of the input radio frequency signal, and output classification results.

In another aspect of the described embodiments, a modulation classification system is provided, which can comprise: a feature extraction circuit configured to extract, from an input modulated radio frequency signal, radio frequency signal features including an envelope amplitude and a frequency; an analog-to-digital converter configured to digitize the extracted radio frequency signal features; and a deep learning neural network configured to receive the digitized radio frequency signal features, classify a modulation type and a symbol rate of the modulated radio frequency signal based on the received digitized radio frequency signal features, and output results of the classification. The extracted radio frequency signal features can be represented by time-series voltages.

In one more aspect of the described embodiments, a modulation classification method is provided, which can comprise: receiving a radio frequency signal; extracting radio frequency signal features that include envelope amplitude and frequency; digitizing the extracted radio frequency signal features; inputting the digitized radio frequency signal features to a deep learning neural network to classify a modulation type and a symbol rate of the radio frequency signal; and outputting results of the classification.

This summary is provided to introduce a selection of the concepts that are described in further detail in the detailed description and drawings contained herein. This summary is not intended to identify any primary or essential features of the claimed subject matter. Some or all of the described features may be present in the corresponding independent or dependent claims but should not be construed to be a limitation unless expressly recited in a particular claim. Each embodiment described herein does not necessarily address every object described herein, and each embodiment does not necessarily include each feature described. Other forms, embodiments, objects, advantages, benefits, features, and aspects of the present disclosure will become apparent to one of skill in the art from the detailed description and drawings contained herein. Moreover, the various systems and methods described in this summary section, as well as elsewhere in this application, can be expressed as a large number of different combinations and sub-combinations. All such useful, novel, and inventive combinations and sub-combinations are contemplated herein, it being recognized that the explicit expression of each of these combinations is unnecessary.

### BRIEF DESCRIPTION OF THE DRAWINGS

While the specification concludes with claims which particularly point out and distinctly claim this technology, it is believed this technology will be better understood from the following description of certain examples taken in conjunction with the accompanying drawings, in which like reference numerals identify the same elements and in which:

FIG. 1 is a block diagram showing an exemplary AMC system in accordance with the present disclosure, which utilizes frequency and envelope amplitude as inputs to a deep learning neural network to identify modulation and rate (symbols per second (SPS)) of an incoming interferer;

FIG. 2 illustrates a flow chart of an AMC method according to an example embodiment of the present disclosure;

FIG. 3 is a block diagram of architecture of the AMC system shown in FIG. 1, wherein time-series voltage signals are extracted from two voltage sensing nodes in a stub-based sensing circuit as input features to the deep learning-based neural network, in accordance with an example embodiment;

FIG. 4 schematically illustrates a conceptual structure of an LSTM-based neural network used for the AMC, in accordance with the present disclosure;

FIG. 5 shows a training performance chart for the neural network;

FIG. 6 (a) illustrates a block diagram and photo of a test setup used for the AMC in accordance with the present disclosure;

FIG. 6 (b) illustrates a feature extraction hardware implemented in the test setup;

FIG. 6 (c) is a resulting confusion matrix from the test setup and the implemented neural network, illustrating classification accuracy;

FIG. 7 illustrates performance of the AMC system in accordance with the present disclosure, under low signal-to-noise (SNR) conditions; and

FIG. 8 is a chart showing a simulated timing breakdown of the neural network layers using the Eyeriss accelerator.

The drawings are not intended to be limiting in any way, and it is contemplated that various embodiments of the technology may be carried out in a variety of other ways, including those not necessarily depicted in the drawings. The accompanying drawings incorporated in and forming a part of the specification illustrate several aspects of the present technology, and together with the description serve to explain the principles of the technology; it being understood, however, that this technology is not limited to the precise arrangements shown, or the precise experimental arrangements used to arrive at the various graphical results shown in the drawings.

### DETAILED DESCRIPTION

The following description of certain examples of the technology should not be used to limit its scope. Other examples, features, aspects, embodiments, and advantages of the technology will become apparent to those skilled in the art from the following description, which is by way of illustration, one of the best modes contemplated for carrying out the technology. As will be realized, the technology described herein is capable of other different and obvious aspects, all without departing from the technology. Accordingly, the drawings and descriptions should be regarded as illustrative in nature and not restrictive.

It is further understood that any one or more of the teachings, expressions, embodiments, examples, etc. described herein may be combined with any one or more of the other teachings, expressions, embodiments, examples, etc. that are described herein. The following described teachings, expressions, embodiments, examples, etc., should, therefore, not be viewed in isolation relative to each other. Various suitable ways in which the teachings herein may be combined will be readily apparent to those of ordinary skill in the art in view of the teachings herein. Such modifications and variations are intended to be included within the scope of the claims.

AMC is a signal processing technique used to identify the modulation scheme of an unknown signal without prior knowledge of the signal's parameters. This technology is crucial for various applications in wireless communication, including cognitive radio, software-defined radio, and spectrum management. Traditional AMC methods rely on in-phase and quadrature (IQ) data, which are vulnerable to imperfections such as gain compression and phase imbalance, especially in the presence of high-power interferers. Existing approaches also fail to identify symbol rates, limiting their utility in dynamic spectrum environments.

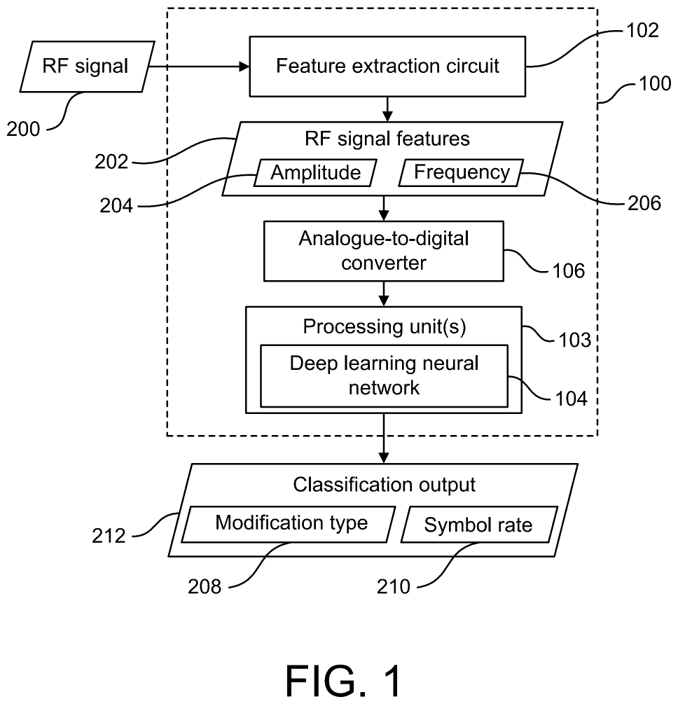

To this end, shown in FIG. 1 is a modulation classification system 100 relying on the envelope of the signal and its frequency readings. The main components of the system 100 comprise a feature extraction circuit 102 and one or more processing units 103. The feature extraction circuit 102 is configured to extract, from an input radio frequency (RF) signal 200 (incoming interferer), radio frequency signal features 202 including an envelope amplitude 204 and a frequency 206. The processing unit(s) is (are) configured to process the envelope amplitude 204 and the frequency 206 so as to classify a modulation type 208 and a symbol rate 210 of the input radio frequency signal 200, and output classification results 212.

The system is computer-implemented and may be embodied in, and partially or fully automated via, software code modules (e.g., in the form of an algorithm or machine-readable instructions) stored in a memory element such as a tangible, non-transitory computer-readable medium executed by the one or more processing unit(s) and other computing devices. The software may be downloaded to the processing unit(s) in electronic form. In embodiments involving multiple processing units, the processing units (processors) may operate in parallel to form a parallel processing system in which a process is split into parts that execute simultaneously on different processors of the system 100. The system may be implemented on the computing devices configured to, in response to execution of software instructions or other executable machine-readable code, read from the memory or tangible computer readable medium. A tangible computer readable medium is a data storage device that can store data that is readable by a computer system. Examples of computer readable mediums include read-only memory (e.g., ROM or PROM, EEPROM), random-access memory, other volatile or non-volatile memory devices, CD-ROMs, magnetic tape, flash drives, and optical data storage devices. As will be appreciated by a person of ordinary skill in the art, computer-executable instructions stored in tangible computer storage media define specific functions to be performed by computer hardware (the processing unit(s) 103). In general, in such an implementation, the computer-executable instructions are loaded into memory accessible by at least one computer processor (for example, a programmable microprocessor or microcontroller or an application specific integrated circuit). The at least one computer processor then executes the instructions, causing computer hardware to perform the specific functions defined by the computer-executable instructions.

In some embodiments, the feature extraction circuit 102 may comprise a stub-based sensing circuit configured to measure standing wave voltages. In some embodiments, the stub-based sensing circuit may be configured to extract envelope amplitude and the frequency of the input radio frequency signal as time-series voltage inputs.

In some embodiments of the system 100, an analog-to-digital converter 106 may be further provided to digitize the extracted radio frequency signal features 202 for processing in the processing unit(s) 103.

In some embodiments, the processing unit(s) 103 can comprise a machine learning model configured to process the envelope amplitude 204 and the frequency 206 and classify a modulation type 208 and a symbol rate 210 of the input radio frequency signal 200. More specifically, in some embodiments, the processing unit(s) 103 can comprise a neural processing unit (NPU), also known as artificial intelligence (AI) accelerator or deep learning processor, which is a class of specialized hardware accelerator or computer system designed to accelerate artificial intelligence and machine learning applications, including artificial neural networks and computer vision.

In some particular embodiments, the processing unit(s) 103 can comprise a deep learning neural network 104. The deep learning neural network 104 is a type of artificial neural network with multiple hidden layers between the input and output layers. These hidden layers enable the network to learn, based on specific algorithms, complex patterns and representations from data, making them suitable for tasks requiring high accuracy and sophisticated understanding. For the purposes of the present system 100, the deep learning neural network 104 may be configured to process radio frequency signal features 202 and perform classification of modulation 208 and rate 210. In one of specific embodiments, the deep learning neural network 104 may be implemented in the form of a Long Short-Term Memory (LSTM) neural network.

Due to the specific configuration of the system 100, the signals are detected in the RF domain without down conversion, making the system 100 significantly more robust against high power interferers, while maintaining an excellent detection accuracy. An efficient envelope and frequency detection circuit is utilized for this task. The deep learning-based system 100 can rely on Long Short-Term Memory (LSTM) neural network, and is capable of distinguishing 1) the modulation 208, and 2) the symbol rate 210 of all the tested waveforms, with accuracy better than 98.9%, and 99.6% on average. The provided symbol rate 210 is essential information to determine the bandwidth occupied by the signal, or if it is to be demodulated. As will be discussed in further details below, the tested modulation waveforms are BPSK, QPSK, 8PSK, 16QAM, and OFDM at 0.5 and 1.5 MSPS, the performance against various signal-to-noise ratios is also measured. The detection time is approximately 9.7 us based on simulation of the neural network on Eyeriss accelerator, which is an energy-efficient reconfigurable accelerator for deep convolutional neural networks. The system 100 thus is ideal for detecting valuable information about high-power interferers.

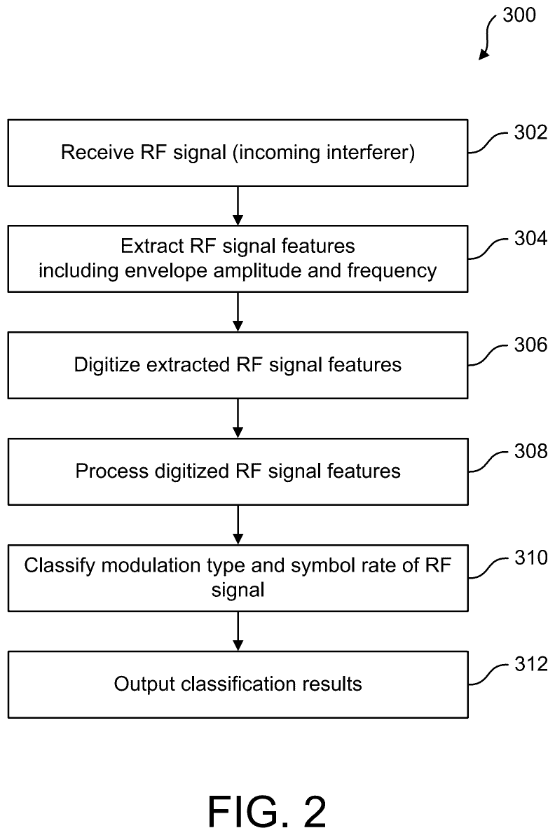

FIG. 2. illustrates a flow chart according to an example method 300 for modulation classification, in accordance with the present disclosure. The method 300 may be performed by a system such as the system 100 described above with the reference to FIG. 1. The method 300 proceeds through the following general operational steps. At operation 302, the radio frequency signal 200 is received by the system 100. At operation 304, the radio frequency signal features 202 including envelope amplitude 204 and frequency 206 are extracted from the received radio frequency signal 200 by the feature extraction circuit 102. In some embodiments, to follow the operation 304, the method may further comprise operation 306, at which the extracted radio frequency signal features 202 are digitized in the analog-to-digital converter 106. At operation 308, the extracted radio frequency signal features 202 (which were, in some embodiments, digitized at operation 306) are then input to the one or more processing units 103 and processed, and at operation 310, classification of a modulation type 208 and a symbol rate 210 of the radio frequency signal 200 is performed in the one or more processing units based on the processed data. At operation 312, the classification results are output from the one or more processing units.

In one of possible embodiments of the method 300, at the operation 304, the radio frequency signal features 202 are extracted as time-series voltage signals from the stub-based sensing circuit.

In other particular embodiments of the method 300, at the operation 306, the radio frequency signal features are digitized in the analog-to-digital converter 106 at a sampling rate of at least 5 MSPS.

In one of possible embodiments of the method 300, at the operations 308 and 310, the digitized radio frequency signal features are processed in a deep learning neural network, preferably, in the LSTM neural network, to classify the modulation type and the symbol rate of the radio frequency signal.

In the method 300, the radio frequency signal features 202 are extracted without performing in-phase and quadrature demodulation.

In one of possible embodiments, the method may comprise adaptive re-sampling upon low classification confidence. In this embodiment, for example, the method 300 may include a confidence validation loop after operation 310, wherein if the neural network's confidence score is below 90%, the system acquires additional signal samples (repeating operations 302-308) and reclassifies, and if confidence remains low (below 90%), the system flags the signal for external analysis.

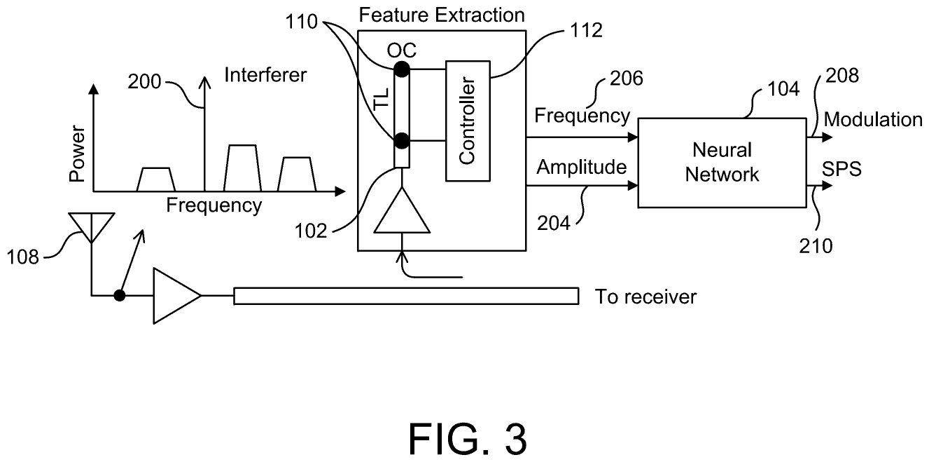

The modulation classification process in accordance with the present disclosure will be now discussed in more details with reference to FIG. 3, which outlines an exemplary particular embodiment of the AMC architecture with its functionality from the initial signal acquisition to the final classification of the modulation type and symbol rate (symbols per second, SPS). On the left side of the diagram shown in FIG. 3, an antenna 108 captures incoming RF signals from the environment, which may include both desired communication signals and potential high-power interferers. The frequency spectrum beneath the antenna 108 shows a conceptual power-frequency profile, highlighting the presence of a narrowband interferer 200. The received signal is directed toward both a receiver path and a parallel signal analysis path that includes a feature extraction block and a neural network block.

The feature extraction is implemented in hardware. Specifically, the hardware implementation of the feature extraction circuit 102 can comprise a transmission line (TL) terminated with an open-circuit (OC) stub, forming a resonant sensing structure (a stub-based sensing circuit) configured to extract both the envelope amplitude 204 and instantaneous frequency 206 of the signal 200. This structure can support the creation of a standing wave pattern along the TL in response to the incident RF signal 200.

The feature extraction circuit 102 can comprise at least two voltage-sensing nodes 110 positioned along the TL, to capture, in time series fashion, local signal voltages, which contain information related to both the envelope (amplitude 204) and instantaneous frequency 206 of the signal 200.

The sensed analog voltages are managed by a controller 112. The controller 112 can perform digitization via onboard analog-to-digital converter(s) (ADC) 106, apply optional preprocessing, and forward the extracted amplitude 204 and frequency 206 features to the neural network 104.

To the right of FIG. 3, the neural network 104 block can receive the amplitude 204 and frequency 206 features as two parallel time-series inputs. In order to successfully classify the modulation 208 of the signal 200 and find its rate 210, the neural network 104 has to process the received descriptive features of it. The neural network 104 is implemented in software. On the software side, the digitized feature vectors are processed by a deep learning model implemented on a general-purpose processor, GPU, or a neural network accelerator. The network 104 can be trained to recognize patterns in these inputs that correspond to specific modulation formats (e.g., BPSK, QPSK, 8PSK, 16QAM, OFDM, CW) and symbol rates. The outputs of the neural network 104 include the modulation type 208 and symbol rate (SPS) 210.

The system thus operates in parallel with the main receiver path and does not interfere with it. Instead, it provides side-channel information that can be used to identify unknown or interfering signals, making the approach particularly suitable for cognitive radio systems, electronic warfare, and dynamic spectrum management applications. The partitioning between hardware and software allows for high-speed, low-latency automatic modulation classification without requiring full demodulation of the signal.

### RF Feature Extraction

Modulated signals typically change the envelope of the carrier, and its phase. While extracting the phase as a feature is ideal, this might not be possible if the frequency of the interferer is unknown. The derivative of the phase, however, is effectively a transient shift in frequency, or

$$ω = {ω}_{carrier} + \frac{δθ ( t )}{δ t} , \qquad ( 1 )$$

where θ(t) is the phase modulation as a function of time. As a result, a relatively fast and accurate measurement of the frequency can be used in lieu of the phase.

While there are commercially available envelope detectors and frequency counters, the stub-based sensing circuit (as shown in FIG. 3) can be utilized here since it reads both, amplitude and frequency simultaneously, over a multi-octave frequency range, wide power dynamic range, and with a sub-microsecond response time. This concept is briefly discussed below for completeness.

Referring back to FIG. 3, the input signal 200 is coupled into the OC stub, which creates a standing wave pattern in it. The amplitude of the standing wave at the open end of the stub is directly proportional to the power of the interferer. On the other hand, the comparative voltage levels away from the open end are functions of frequency. As a result, the time series voltages from two sensing nodes 110 on the stub are extracted as input features for the neural network 104 since they carry both information, namely envelope (amplitude 204) and frequency 206.

The analog voltage outputs from the sensing nodes 110 can be subsequently digitized using high-speed analog-to-digital converters 106 by sampling at at least 5 MSPS in one of possible embodiments (e.g., LTC2315CTS8 ADCs can be used, operating at 5 MSPS). The digitized voltage streams are then forwarded to a digital processing unit, such as an FPGA (e.g., Cyclone IV), which manages the interface between the ADCs and the software layer.

### Neural Network Structure

Time series classification is a typical problem to be solved by Recurrent Neural Networks (RNN) such as LTSM networks. Therefore, in one of possible embodiments, the deep learning neural network 104 can be implemented as an LTSM network.

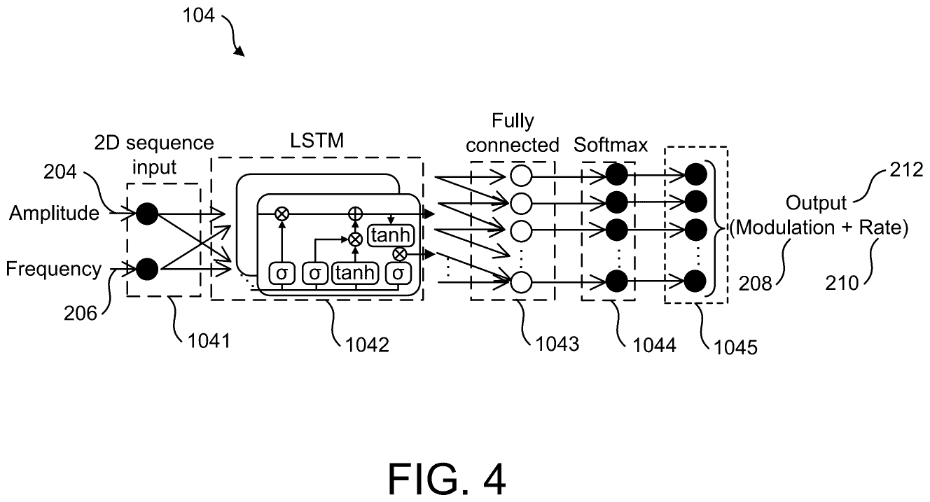

In an exemplary implementation, the classification algorithm is realized in the LSTM network using a five-layer architecture, the conceptual structure of which is shown in FIG. 4. However, in some alternative embodiments, any other number of multiple layers can be implemented.

As illustrated in the particular example of FIG. 4, the five-layer structure of the LSTM network 104 is constructed as follows: 1) a two-dimension sequence input layer 1041, 2) an LSTM layer 1042, 3) an N-dimensional fully connected layer 1043, 4) an N-dimension Softmax layer 1044, and 5) a classification output layer 1045. The two-dimension sequence input (amplitude 204 and frequency 206) layer 1041 represents the input to the neural network 104 in a time series fashion. The LSTM layer 1042 can be a 600-unit LSTM layer. In the LSTM layer 1042 current input data, and the previous data points are processed and correlated. The N-dimensional fully connected layer 1043 takes the output of the LSTM layer 1042, and processes it according to the training weights. The N-dimension Softmax layer 1044 computes the probability of each possible outcome. And finally, the classification output layer 1045 is where the actual classification output 212 is delivered. Here, N is the number of distinct signal modulations to be classified.

In an alternative low-power embodiment, the LSTM layer 1042 may be replaced with a Gated Recurrent Unit (GRU) layer, which retains similar temporal modeling capabilities but with fewer parameters. Testing showed a<1% accuracy drop for GRUs, while latency improved by 15%.

Alternatively, an attention mechanism may be inserted between the LSTM layer 1042 and the N-dimensional fully connected layer 1043. This weights specific time segments of the amplitude 204 and frequency 206 inputs (e.g., during symbol transitions), improving classification of burst-mode signals.

The network 104 can be trained offline using labeled modulation data and executed in real-time using a host PC or a dedicated edge-AI platform. In some embodiments, the software can be deployed on energy-efficient accelerators such as the Eyeriss neural network processor, achieving classification latency of approximately 9.7 microseconds per inference.

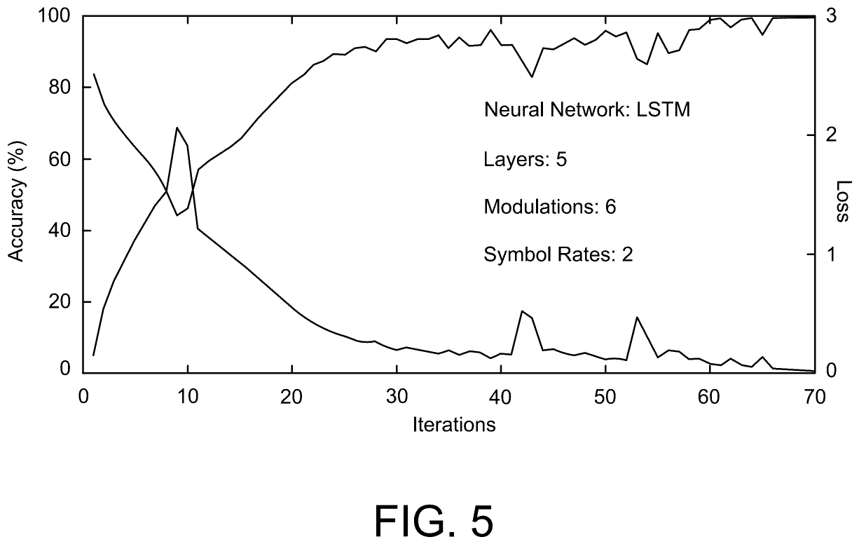

FIG. 5 illustrates the training performance of the LSTM-based neural network in one of particular examples. In this example, the neural network 104 is trained with the input signal modulated as: 1) BPSK, 2) QPSK, 3) 8PSK, 4) 16QAM, 5) OFDM (16-subcarrier), and 6) CW. The training data set contains 8192 sample points for each modulation. The plot presents the evolution of classification accuracy and training loss as functions of training iterations. The left y-axis indicates classification accuracy (in percentage), while the right y-axis represents the loss function, commonly measured as mean squared error or cross-entropy. The x-axis shows the number of training iterations, from 0 to 70.

The training shows that, at about 70 training iterations, the accuracy is over 99.7%, and the mean-squared error loss is below 0.025 (the loss here is a machine learning term indicating how far the training data is from the ideal values). As observed, the network begins with low accuracy and high loss. However, as training progresses, the accuracy rapidly increases-exceeding 80% within the first 10 iterations—and eventually surpasses 99% by approximately iteration 30. Concurrently, the loss decreases significantly and stabilizes below 0.025 near the end of training. FIG. 5 demonstrates the high classification capability and convergence efficiency of the proposed architecture, which is crucial for real-time AMC applications.

To enhance adversarial robustness, the training dataset may include synthetic interferers (e.g., signals with intentional phase noise or pulsed jamming). The neural network 104 learns to ignore such distortions, maintaining >95% accuracy even with 20 dB interference-to-signal ratios.

In another approach, the loss function may prioritize symbol rate 210 accuracy over modulation type 208 (e.g., by weighting rate errors 2× higher). This is useful for applications where bandwidth occupancy is critical (e.g., spectrum policing).

### Automatic Modulation Classification Test Setup Results

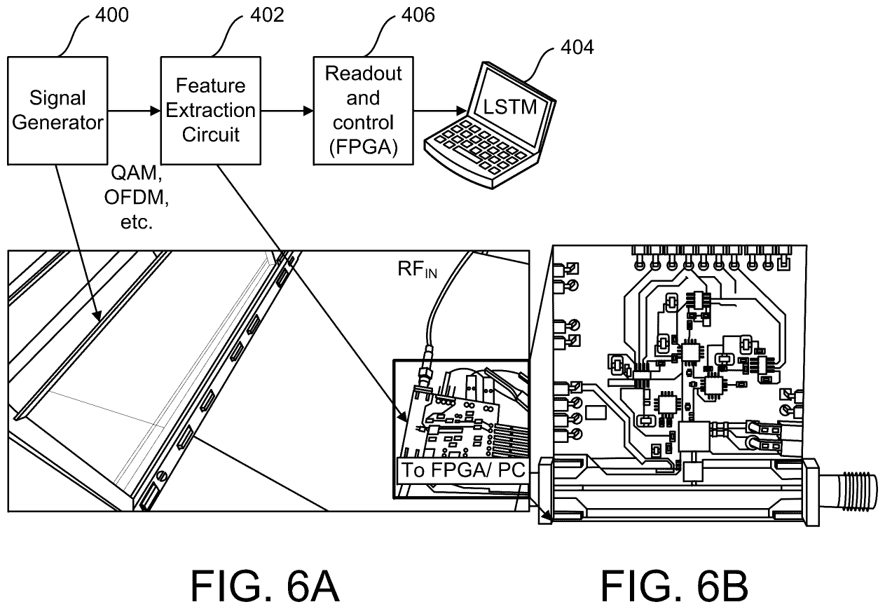

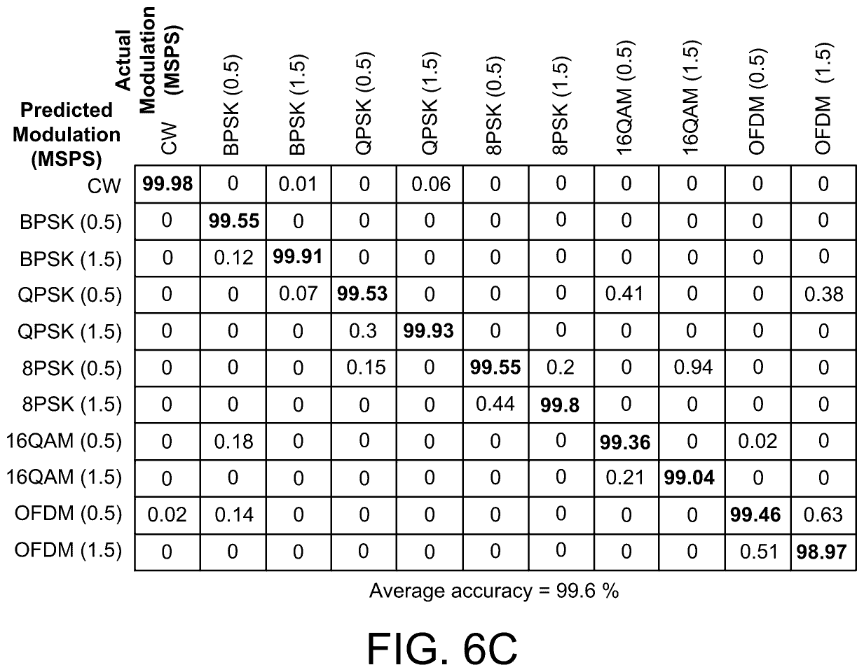

FIG. 6 (a) illustrates a block diagram and photo of a test setup used to run AMC in accordance with the present disclosure. A signal generator 400 injects a modulated signal into the feature extraction circuit 402 (like the feature extraction circuit 102 shown in FIG. 3), and the LSTM neural network 404 (like the neural network 104 shown in FIGS. 3 and 4) classifies the new unseen input data.

FIG. 6 (b) shows the feature extraction hardware. The on-board ADCs (like the ADC 106 of the controller 112 shown in FIG. 3) digitize the features' voltages, and a Cyclone IV FPGA reads them out (as shown by position 406 in FIG. 3) so they can be used by the neural network 404 on the PC. The frequency of the tested input carrier signal is 4 GHz at 0 dBm power. The modulations are also tested at two different symbol rates, 0.5 and 1.5 MSPS.

The test setup may integrate a real-time spectrum analyzer (not shown) to validate the neural network's output 212. Discrepancies trigger reclassification or hardware recalibration.

FIG. 6 (c) shows the resulting confusion matrix from a new unseen data set. The neural network 404 is able to classify the modulation type and the symbol rate with 99.6% success rate, in average. The modulation classification accuracy for each case, also shown in the figure, remains above 98.9%. The feature extraction circuit 402 is capable of operating over a wide frequency range (1-16 GHZ), and a power dynamic range covering −20-20 dBm.

It is to be noted here that the method can clearly distinguish CW signals from constant envelope ones (e.g., BPSK or QPSK). This indicates that the fast frequency detection method utilized here can successfully quantify phase modulations as described by Formula (1) above.

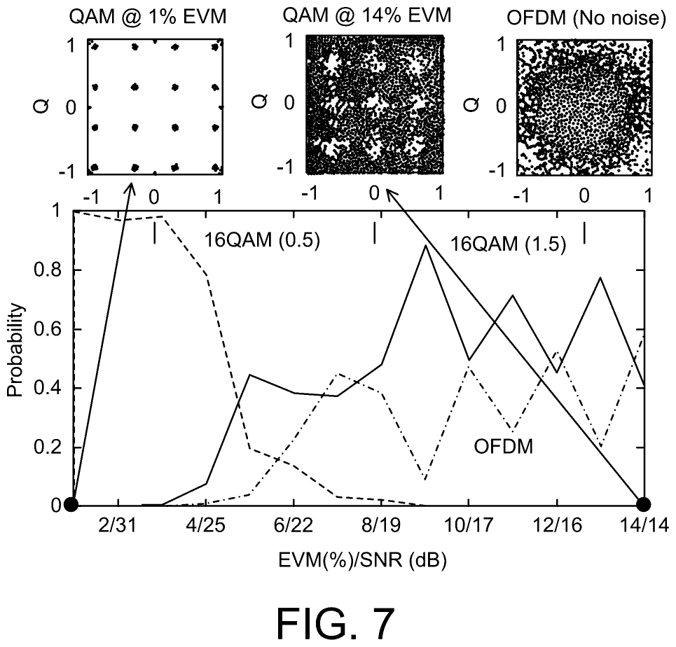

In the presence of noise, the randomness in the amplitudes of the input features increase the confusion in the classification. In order to quantify this, the AMC is tested under various signal-to-noise ratios (SNR), resulting in different Error Vector Magnitudes (EVM). The results, shown in FIG. 7, show that at high SNR, the neural network is able to properly identify the modulation. As the SNR starts to degrade, however, the modulation classification gradually shifts towards other modulation. The top three output modulation classifications are plotted. It is to be noted that, at higher noise levels (lower SNR), the signal is more likely to be classified as OFDM. To justify this behavior, FIG. 7 shows a 16QAM signal constellation (with and without noise) compared to that of OFDM. OFDM-modulated signals show a noise-like constellation, causing the confusion at low SNR.

The system may implement an adaptive SNR threshold (e.g., 10 dB). Below this threshold, the neural network 104 switches to a “low-confidence” mode, averaging classifications over 10× longer windows or flagging results for human review.

Alternatively, a wavelet-based denoising algorithm may pre-process the envelope amplitude 204 and frequency 206 inputs, improving classification accuracy by up to 12% at 5 dB SNR.

### Timing Results

In time-critical systems, the delay between the debut of the interferer 200 and the classification decision output 212 is essential to analyze. This time delay consists of the circuit 102 and the neural network 104 response times. The circuit response time is sub-μs and is considered negligible compared to the overall response time.

In order to analyze the timing of the neural network, SCALE-SIM is used. SCALE-SIM is a neural network simulator that provides cycle-accurate results, including memory access and runtime. The assumed platform is Eyeriss accelerator, an energy-efficient reconfigurable accelerator for neural networks. The utilized neural network (which is as shown in FIG. 4) is simulated accordingly and the overall number of cycles required for classifications is 1957.

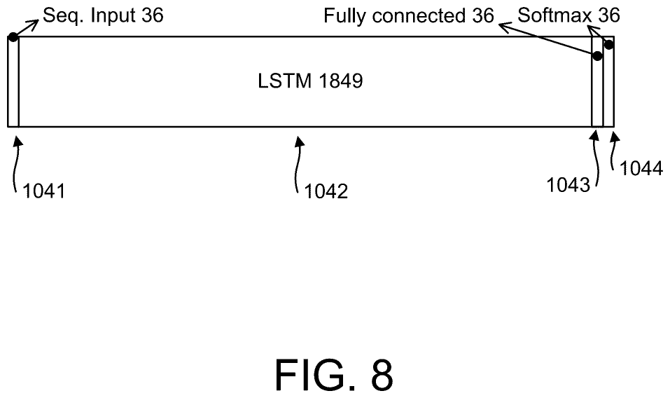

FIG. 8 shows the individual layer contributions of the LSTM neural network. The symbolic structure of the neural network layers is particularly shown along with simulated number of clock cycles required to run the network (excluding the classification output layer, assumed negligible) using the Eyeriss accelerator. As can be seen in the chart, the contribution of each of the two-dimension sequence input layer 1041, N-dimensional fully connected layer 1043 and N-dimension Softmax layer 1044 is 36 cycles, and the contribution of the LSTM layer 1042 is 1849 cycles. Thus, it can be seen that the timing is mostly dictated by the LTSM layer.

At a clock rate of 200 MHz, the neural network response time is approximately 9.7 μs.

Further improvement on the response time can be achieved with a smaller LSTM layer 1042, at the expense of lower classification accuracy, or a faster processor, at the expense of higher power consumption.

Table 1 compares the proposed envelope-based AMC with the existing neural network-based modulation classification methods (Comparative Examples 1-3).

TABLE 1

| | Input | Signal | | Classification | Accuracy | | |
|---|---|---|---|---|---|---|---|
| Ref. | Features | Source | Modulations | output | (%) | Timing | |
| Comparative | I, Q, | Model | CPFSK, GFSK, | Modulation | 93.8-99.6 | NA | |
| Example 1 | frequency | | PAM4, QPSK | | | | |
| Comparative | I, Q | Model | 8PSF, AM, BPSF, | Modulation | ~85 | NA | |
| Example 2 | | | CPFSK, GFSK, | | | | |
| | | | PAM4, 16QAM, | | | | |
| | | | 64QAM, QPSK, | | | | |
| | | | WBFM | | | | |
| Comparative | I, Q | Model | 8PSK, AM, BPSK, | Modulation | ~90 | >1 | ms |
| Example 3 | | | CPFSK, GFSK, | | | | |
| | | | PAM4, 16QAM, | | | | |
| | | | 164QAM, QPSK, | | | | |
| | | | WBFM | | | | |
| Envelope- | Envelope | Measured | OFDM, BPSK, | Modulation | 98.7-99.9 | 9.7 | μs |
| based AMC | (amplitude), | | QPSK, 8PSK, | and Rate | | | |
| | Frequency | | 16QAM | | | | |

Comparative Example 1 employs a deep ensemble-based architecture for automatic modulation classification (AMC), combining multiple neural networks. The method processes IQ (in-phase/quadrature) samples and frequency-domain features from modeled signals, using convolutional neural networks (CNNs) and LSTM layers to classify CPFSK, GFSK, PAM4, and QPSK with accuracy of 93.8-99.6%.

Comparative Example 2 is a deep learning-based method for modulation recognition, using raw IQ samples as input to a CNN. The network is trained on synthetic signals to classify 10 modulation types (8PSK, AM, BPSK, CPFSK, GFSK, PAM4, 16QAM, 64QAM, QPSK, WBFM), achieving about 85% accuracy.

Comparative Example 3 proposes a CNN-based architecture specifically optimized for radio modulation recognition. Like Prior Art 2, it processes raw IQ samples from modeled signals but improves accuracy (about 90%) through deeper network structures and refined training techniques. However, this comes at the cost of increased computational complexity, resulting in slow inference times (>1 ms per classification).

In contrast to the Comparative Examples 1-3, the proposed envelope-based AMC leverages measured signal envelope (amplitude) and frequency features, enabling robust classification of OFDM, BPSK, QPSK, 8PSK, and 16QAM while also identifying modulation rates. With 98.7-99.9% accuracy and a rapid 9.7 us latency, it outperforms prior methods in both practicality (using real-world signals) and functionality (adding rate detection). Notably, the envelope-based AMC is the only method that has measured results, rather than simulation models, including OFDM modulation for the first time.

The presented deep learning-based AMC method thus advantageously relies on envelope and frequency of the incoming signal. As a result, the operation of the AMC method does not rely on a linear demodulation and extraction of IQ channels, making it faster and more robust to operate on unidentified high-power interferes. The method is also capable of identifying the modulation rate. The proof-of-concept results were obtained using measured signals passing through a feature-extraction circuits. The achieved classification accuracy is about 99.6% across several modulations, including OFDM (demonstrated for the first time in the envelope-based AMC, as mentioned above). The performance of the classification was tested under various noise conditions, and its timing was analyzed in simulations. The presented concepts are a strong candidate for identifying the nature of non-cooperative interferers in a timely manner.

While examples, one or more representative embodiments and specific forms of the disclosure have been illustrated and described in detail in the drawings and foregoing description, the same is to be considered as illustrative and not restrictive or limiting. The description of particular features in one embodiment does not imply that those particular features are necessarily limited to that one embodiment. Some or all of the features of one embodiment can be used in combination with some or all of the features of other embodiments as would be understood by one of ordinary skill in the art, whether or not explicitly described as such. One or more exemplary embodiments have been shown and described, and all changes and modifications that come within the spirit of the disclosure are desired to be protected.

I/We claim:

1. A modulation classification system, comprising:
a feature extraction circuit configured to extract an envelope amplitude and a frequency of an input radio frequency signal; and
one or more processing units configured to:
process the envelope amplitude and the frequency to classify a modulation type and a symbol rate of the input radio frequency signal, and
output classification results.

2. The system of claim 1, wherein the feature extraction circuit comprises a stub-based sensing circuit comprising at least two sensing nodes configured to measure standing wave voltages.

3. The system of claim 2, wherein the extracted envelope amplitude and the frequency of the input radio frequency signal are represented as time-series voltage inputs from the at least two sensing nodes.

4. The system of claim 1, wherein the feature extraction circuit is capable of operating over a frequency range from about 1 GHz to about 16 GHz.

5. The system of claim 1, further comprising an analog-to-digital converter configured to digitize the extracted envelope amplitude and frequency.

6. The system of claim 5, wherein the one or more processing units is configured to process the frequency and envelope amplitude received in a digitized form from the analog-to-digital converter.

7. The system of claim 5, wherein the analog-to-digital converter is configured to digitize the extracted envelope amplitude and frequency at a sampling rate of at least 5 MSPS.

8. The system of claim 1, wherein the one or more processing units comprises a deep learning neural network.

9. The system of claim 8, wherein the deep learning neural network comprises a 600-unit Long Short-Term Memory layer configured to process and correlate current input data comprising the envelope amplitude and the frequency, and previous data points.

10. The system of claim 9, wherein the current input data comprising the envelope amplitude and the frequency is represented as a two-dimension sequence input in a time series fashion.

11. The system of claim 10, wherein the deep learning neural network further comprises a layer configured to process an output of the Long Short-Term Memory layer according to training weights.

12. The system of claim 11, wherein the deep learning neural network further comprises a layer configured to compute probability of each possible outcome resulting of the processing according to the training weights.

13. The system of claim 12, wherein the deep learning neural network further comprises a classification output layer configured to output the classification results.

14. A modulation classification system, comprising:
a feature extraction circuit configured to extract, from an input modulated radio frequency signal, radio frequency signal features including an envelope amplitude and a frequency, wherein the extracted radio frequency signal features are time-series voltages;
an analog-to-digital converter configured to digitize the extracted radio frequency signal features; and
a deep learning neural network configured to receive the digitized radio frequency signal features, classify a modulation type and a symbol rate of the modulated radio frequency signal based on the received digitized radio frequency signal features, and output results of the classification.

15. A modulation classification method, comprising:
receiving a radio frequency signal;
extracting radio frequency signal features including envelope amplitude and frequency;
digitizing the extracted radio frequency signal features;
inputting the digitized radio frequency signal features to a deep learning neural network to classify a modulation type and a symbol rate of the radio frequency signal; and
outputting results of the classification.

16. The method of claim 15, wherein the radio frequency signal features are extracted as time-series voltage signals from two sensing nodes of a stub-based sensing circuit.

17. The method of claim 15, wherein the radio frequency signal features are digitized at a sampling rate of at least 5 MSPS.

18. The method of claim 15, wherein the digitized radio frequency signal features are processed in a Long Short-Term Memory neural network to classify the modulation type and the symbol rate of the radio frequency signal.

19. The method of claim 15, wherein the radio frequency signal features are extracted without performing in-phase and quadrature demodulation.
